(19) United States
(12) Patent Application Publication
(10) Pub. No.: US 2018/0202138 A1
(43) Pub. Date: Jul. 19, 2018

(54) Toilet Bowl Disinfectant Tissue

(71) Applicant: Francis Johnson, Spring, TX (US)

(72) Inventor: Francis Johnson, Spring, TX (US)

(21) Appl. No.: 15/406,635

(22) Filed: Jan. 13, 2017

(51) Int. Cl. E03D 9/00; A01N 37/36; A01N 59/00; A01N 25/08; C11D 17/04

(52) U.S. Cl. CPC E03D 9/005; A01N 37/36; C11D 17/049; A01N 25/08; A01N 59/00

(57) ABSTRACT

A sanitary cleaning disinfectant tissue is comprised of but not limited to natural or synthetic fibers bonded together and impregnated with sanitizing chemicals including but not limited to surfactant, sodium hypochlorite, ammonia, leaf protein concentrate, glycerin, fragrance, and citric acid uniformly distributed therein by applying a predetermined quantity of treating fluid to any portion of the non-treated material, which is operable for cleaning the inside toilet bowl or similar submerged surfaces. The material can be interwoven and impregnated with a crystal non-aqueous agent which creates a film that adheres to the bowl.

This patent claims the benefit of provisional patent 62/278,327

### BACKGROUND

The present invention relates to apparatuses for cleansing toilet bowls. More specifically this invention relates to devices or articles used for cleaning toilet bowls. Conventionally, a toilet bowls are cleaned by brushing a sanitizing a disinfectant around the interior of the toilet bowl. First, the disinfectant cleanser is sprayed completely surrounding the interior of the bowl. Then, a brush is used to spread and scrub the interior of the bowl with the disinfectant cleanser.

In another method, a disinfectant device is mounted within the interior of the bowl or within the tank of the bowl. When the toilet is flushed the water impregnates the disinfectant device causing sanitizing fluid to be dispersed within the water of the toilet bowl. The toilet bowl is automatically sanitized as the water emerges and surrounds the interior of the bowl. The present invention discloses a disposable disinfecting device that is novel.

### SUMMARY

The present invention provides a sanitary cleaning disinfectant tissue comprised of but not limited to natural or synthetic fibers bonded together and impregnated with sanitizing chemicals including but not limited to surfactant, sodium hypochlorite, ammonia, leaf protein concentrate, glycerin, fragrance, and citric acid, which are operable for cleaning the inside toilet bowl or similar submerged surfaces without direct contact application of the hands. The sanitary cleaning disinfectant tissue is dropped into the toilet bowl. The toilet is flushed. The sanitary cleaning disinfectant tissue which is biodegradable cleans the inside of the toilet bowl while being flushed. The Sanitary wipe also prevents back splashing.

One of the objectives of this disinfectant tissue is to provide an efficient sanitary device to use while traveling.

Another objective is to provide an effective aroma device for toilets while traveling.

Another object is to provide a film that prevents water from back splashing.

Another object is to provide a crystal agent that have an adhesive component that attaches to the internal of the toilet bowl.

### BRIEF DESCRIPTION OF DRAWINGS

FIG. 1 is an illustrative view of the product.

### DESCRIPTION

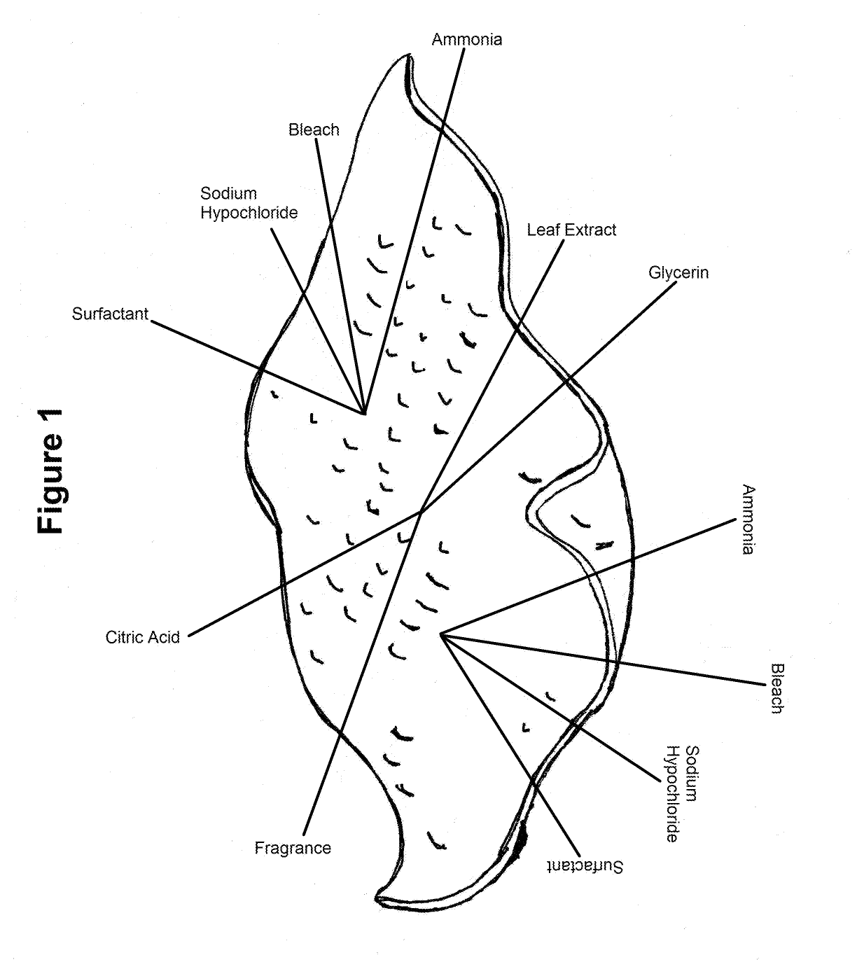

As shown in FIG. 1, the sanitary cleaning disinfectant tissue is impregnated with various fragrance elements and various chemical elements in various sections of the disinfectant tissue. In the preferred embodiment the fragrance chemical elements consists of fragrance and leaf protein concentrate. The disinfectant chemical elements consists of surfactant, sodium hypochlorite, ammonia, glycerin, and citric acid. As shown the fragrance chemical elements are situated in the center of the disinfectant tissue and the disinfectant chemical elements are disposed on opposing sides of the disinfectant tissue. Various permutations of the fragrance chemical elements and the disinfectant chemical elements can be impregnated in various sections of the disinfectant tissue.

The sanitary cleaning disinfectant tissue is preferably made from a hydra-spun material which is developed during a wet-laid process using high-pressure water jets (hydro-entanglement) to create blends of natural and synthetic fibers without latex binders. The resultant products are soft and thick, strong and absorbent. Also, the sanitary cleaning disinfectant tissue is biodegradable, dispersible and flushable. The sanitary cleaning disinfectant tissue has a neutral odor and provides excellent lotion distribution. The sanitary cleaning disinfectant tissue is impregnated with surfactant, sodium hypochlorite or bleach, ammonia, leaf protein concentrate or leaf extract, glycerin, fragrance, and citric acid. When tissue drops into the water the chemicals therein disperses. Fragrance, citric acid, and leaf extract controls the unpleasant odors. Surfactant, sodium hypochlorite, ammonia, and glycerin facilitates the sanitizing of the toilet bowls.

Surfactants are wetting agents that lower the surface tension of a liquid, allowing easier spreading, and lower the interfacial tension between two liquids.

Sodium hypochlorite is a chemical compound with the formula NaOCL and is commonly known as bleach which is frequently used as a disinfectant and as a bleaching agent. During wastewater treatment, an alkaline solution (pH 11.0) of sodium hypochlorite is used to treat dilute (<1 g/L) cyanide wastewater, e.g. rinse water from an electroplating shop. In batch treatment operations, sodium hypochlorite has been used to treat more concentrated cyanide wastes, such as silver cyanide plating solutions. A well-mixed solution is fully treated when an excess of chlorine is detected. Sodium hypochlorite in the form of household bleach is often used to oxidize foul-smelling wastes generated in a chemistry laboratory.

Ammonia is a compound with the formula NH3. When used commercially, ammonia is often called anhydrous ammonia. This term emphasizes the absence of water in the material. Ammonia is sometimes added to drinking water along with chlorine to form chloramines, a disinfectant.

Leaf protein concentrate (LPC) is a concentrated form of the proteins found in the leaves of plants. It has been examined as a human or animal food source, because it is potentially the cheapest, most abundant source of available protein.

Glycerol is a chemical compound with the formula HOCH2CH (OH)CH2OH. This colorless, odorless, viscous liquid is widely used in pharmaceutical formulations. Also commonly called glycerin, it is a sugar alcohol, and is sweet-tasting and of low toxicity. Glycerol has three hydrophilic alcoholic hydroxyl groups that are responsible for its solubility in water and its hygroscopic nature. Since glycerol forms the backbone of triglycerides, it is produced on saponification or transesterification. Soap-making and bio-diesel production are respective examples. One potential use for glycerol includes the production of citric acid.

An aroma compound, also known as fragrance, is a chemical compound that has a smell or odor. A chemical compound has a smell or odor when two conditions are met: the compound needs to be volatile, so it can be transported to the olfactory system in the upper part of the nose, and it needs to be in a sufficiently high concentration to be able to interact with one or more of the olfactory receptors.

Citric acid is a weak organic acid. It is a natural preservative and is also used to add an acidic, or sour, taste to foods and soft drinks. In biochemistry, it is important as an intermediate in the citric acid cycle and therefore occurs in the metabolism of almost all living things. It also serves as an environmentally benign cleaning agent and acts as an antioxidant. Citric acid's ability to chelae metals makes it useful in soaps and laundry detergents. By chelating the metals in hard water, it lets these cleaners produce foam and work better without need for water softening. In a similar manner, citric acid is used to regenerate the ion exchange materials used in water softeners by stripping off the accumulated metal ions as citrate complexes.

The tissue is interwoven and impregnated with crystal agents. The material can be interwoven and impregnated with a crystal non-aqueous agent which creates a film that adheres to the bowl. Alternatively, each crystal can be formed containing a composite of the disinfectant agents and/or fragrance agents identified above. When the tissue impacts with the water within the toilet bowl the crystal dissolves forming a film that adheres to the inner toilet bowl. Each crystal may have an adhesive component that attaches to the inner toilet bowl.

In use, the sanitary cleaning disinfectant tissue is adapted for cleaning the inside toilet bowl or similar submerged surfaces without direct contact application of the hands. The fragrance and disinfectant chemicals are dried and incorporated into the layers of the sanitary disinfectant tissue. Then, the sanitary cleaning disinfectant tissue is dropped into the water of the toilet bowl and overlays the top of the water in the water bowl.

Once the sanitary cleaning disinfectant tissue is dropped into the toilet bowl it releases cleaning chemicals and fragrances to eliminate odors and unwanted water splashes while sanitizing the bowl all at the same time. After the toilet is flushed, the chemicals within the sanitary cleaning disinfectant tissue dissolves into the water thereby cleaning the inside of the toilet bowl as the disinfectant tissue is being flushed into the sewage system. After the toilet is flushed, the chemicals for the sanitary cleaning disinfectant tissue has a composition that disperses from the tissue and remains. The tissue also have a composition that disperses from the tissue and remains and clings to the interior of the bowl. The chemical composition will be able to form a protective sealant upon the interior of the bowl for a predetermine period of time ranging from minutes to days. The following chemicals may be include in the chemical composition:
Thickening agent such as Hydroxyethylcellulose;
A foaming agent such as Cocamide MEA;
A sodium carbonate agent such as Dichlorodimethyl Hydantoin and/or

Dichloroethylmethyl Hydantoin;
and a crystallizing agent such as Silica.

Additionally, the disinfectant tissue is dropped within the center of the toilet bowl absorbs water, floats on the top of the water and remains there preventing water splashing upon the bottom of a person while defecating within the toilet bowl.

1. (canceled)

2. An article for use in combination with an operational toilet bowl connected to and in fluid communication within a sewage system, the article comprising:
a tissue having a circumference or a perimeter slightly smaller than the circumference of the operational toilet bowl wherein the tissue can lye atop the water contained in the operational toilet bowl thereby covering substantially the central part of the water within the operational toilet bowl preventing water backsplash;
the tissue being made of a plurality of interwoven fibers;
the tissue being segmented into one or more sections;
the one or more sections being impregnated with a plurality of crystal agents wherein each crystal agent is selected from the group consisting of one or more aroma chemical elements, one or more disinfectant chemical elements or a combination thereof;

3. The article of claim 1 wherein the plurality of fibers are made of a biodegradable material.

4. The article of claim 1 wherein the crystal agents are made of a non-aqueous material.

5. The article of claim 1 wherein the plurality of fibers is made of a material selected from the group consisting of natural fibers, synthetic fibers or a combination thereof.

6. The article of claim 1 wherein the aroma chemical element is selected from the group consisting of fragrance mixture, a leaf protein concentrate, or a combination thereof.

7. The article of claim 1 wherein the disinfectant chemical element is selected from the group consisting of surfactant, sodium hypochlorite, ammonia, glycerin, and citric acid.

8. The article of claim 1 wherein the tissue is made of a material with a plurality of interwoven fibers wherein each fiber is made of a soft and absorbent material.

9. The article of claim 1 wherein the tissue is made of a material with a plurality of interwoven fibers wherein each fiber is made of a material that is thick.

10. The article of claim 1 wherein the tissue is made of a material with a plurality of interwoven fibers wherein each fiber is made of a material that is strong and flexible.

11. The article of claim 1 wherein the disinfectant chemical element further comprises an agent selected from the group consisting of a thickening agent, a foaming agent, a sodium carbonate agent.

12. The article of claim 1 wherein the tissue further comprises a protective compound element which dissolves in water to for a sealant that clings to the surrounding interior wall of the toilet bowl for a predetermined period of time.

13. The article of claim 1 wherein the disinfectant chemical element further comprises a foaming agent that is Cocamide MEA.

14. The article of claim 1 wherein the disinfectant chemical element further comprises a thickening agent that is Hydroxetylcellouse.

15. The article of claim 1 wherein the disinfectant chemical element further comprises a sodium carbonate agent that is Dichlorodimethyl Hydanton.

16. The article of claim 1 wherein the disinfectant chemical element further comprises a sodium carbonate agent that is Dichloroethylmethyl Hydanton.

17. The article of claim 1 wherein the crystal agent is made of Silica.
